(19) United States
(12) Patent Application Publication
(10) Pub. No.: US 2014/0270362 A1
(43) Pub. Date: Sep. 18, 2014

(54) FAST EDGE-BASED OBJECT RELOCALIZATION AND DETECTION USING CONTEXTUAL FILTERING

(71) Applicant: QUALCOMM INCORPORATED, San Diego, CA (US)

(72) Inventors: Seyed Hesameddin Najafi Shoushtari, San Diego, CA (US); Yanghai Tsin, San Diego, CA (US); Murali Ramaswamy Chari, San Diego, CA (US); Serafin Diaz Spindola, San Diego, CA (US)

(73) Assignee: QUALCOMM INCORPORATED, San Diego, CA (US)

(21) Appl. No.: 13/844,692

(22) Filed: Mar. 15, 2013

(51) Int. Cl. G06K 9/00

(52) U.S. Cl. CPC G06K 9/00771
USPC 382/103

(57) ABSTRACT

Embodiments include detection or relocalization of an object in a current image from a reference image, such as using a simple and relatively fast and invariant edge orientation based edge feature extraction, then a weak initial matching combined with a strong contextual filtering framework, and then a pose estimation framework based on edge segments. Embodiments include fast edge-based object detection using instant learning with a sufficiently large coverage area for object re-localization. Embodiments provide a good trade-off between computational efficiency of the extraction and matching processes.

### FIELD

The subject matter disclosed herein relates to edge detection in images, and in particular to fast edge-based object relocalization and detection.

### BACKGROUND

Object detection, tracking and relocalization are used in vision-based applications. For example, object detection, tracking and relocalization may be used with a captured camera image to estimate the camera's position and orientation (pose) so that augmented content can be stably displayed. Many state-of-the-art feature based object detection systems include feature extraction and object matching steps. A feature based object detection system may detect and match edges of an object in a prior or reference frame with the corresponding edges in a current frame to determine a relative location of the object and the relative position and orientation (pose) of a camera taking the images in the two frames. Such object detection may be part of tracking the object and determining camera pose in real time Augmented Reality (AR) applications. Conventional object detection techniques have high computational complexity overhead, either because of (i) complexity of descriptors or feature extractors, or (i) a high complexity matching process (when descriptors or feature extractors are less complex).

Many current vision-based object detection systems are also limited to textured objects, where corners/blob-like features are used for matching. To the extent that existing approaches address the problem of detecting texture-less objects using edge features in real-time, they require a time consuming off-line learning stage to create a large training data set that defines the coverage area of the detector. Particularly, during object re-localization such a training set is not available and a long training time cannot be tolerated for real time detection of an object.

Therefore, there is a need for more robust and fast vision-based object detection systems.

### SUMMARY

Embodiments of this invention include methods, devices, systems and means for fast edge-based object re-localization and detection. Embodiments of this invention include detection using instant learning with a sufficiently large coverage area for object re-localization. Embodiments of this invention provide a good trade-off between computational efficiency of the extraction and matching processes. Some embodiments include a simple and relatively fast and invariant edge feature extraction method, then a weak initial matching, combined with a strong contextual filtering framework, and then a pose estimation framework based on edge segments.

Some embodiments are directed to a machine implemented method to perform detection or relocalization of an object in a current frame (CF) image from a reference frame image (RF), comprising: calculating CF and RF edge profile illumination intensity gradients of CF and RF image data within a predetermined radius from a location of each of a plurality of CF and RF edge features of a CF and a RF, and along a normal direction of each of the plurality of CF and RF edge features; selecting CF and RF edge features having at least one extrema of the CF and RF profile gradients within the predetermined radius; and identifying at least one CF and RF patch for each selected CF and RF edge feature based on at least one distance between the CF and RF edge feature and at least one location of a local extrema of the CF and RF profile gradients.

Some embodiments are directed to a device comprising: an object detection or relocalization computer module to perform detection or relocalization of an object in a current frame (CF) image from a reference frame image (RF), the module configured to: calculate CF and RF edge profile illumination intensity gradients of CF and RF image data within a predetermined radius from a location of each of a plurality of CF and RF edge features of a CF and a RF, and along a normal direction of each of the plurality of CF and RF edge features; select CF and RF edge features having at least one extrema of the CF and RF profile gradients within the predetermined radius; and identify at least one CF and RF patch for each selected CF and RF edge feature based on at least one distance between the CF and RF edge feature and at least one location of a local extrema of the CF and RF profile gradients.

Some embodiments are directed to a computer program product comprising a computer-readable medium comprising code to perform detection or relocalization of an object in a current frame (CF) image from a reference frame image (RF), the code for: calculating CF and RF edge profile illumination intensity gradients of CF and RF image data within a predetermined radius from a location of each of a plurality of CF and RF edge features of a CF and a RF, and along a normal direction of each of the plurality of CF and RF edge features; selecting CF and RF edge features having at least one extrema of the CF and RF profile gradients within the predetermined radius; and identifying at least one CF and RF patch for each selected CF and RF edge feature based on at least one distance between the CF and RF edge feature and at least one location of a local extrema of the CF and RF profile gradients.

Some embodiments are directed to a computing device to perform detection or relocalization of an object in a current frame (CF) image from a reference frame image (RF), comprising: a means for calculating CF and RF edge profile illumination intensity gradients of CF and RF image data within a predetermined radius from a location of each of a plurality of CF and RF edge features of a CF and a RF, and along a normal direction of each of the plurality of CF and RF edge features; a means for selecting CF and RF edge features having at least one extrema of the CF and RF profile gradients within the predetermined radius; and a means for identifying at least one CF and RF patch for each selected CF and RF edge feature based on at least one distance between the CF and RF edge feature and at least one location of a local extrema of the CF and RF profile gradients.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 is an example of a flow diagram of process to perform object detection, tracking and relocalization.

FIG. 2A shows an example of a flow diagram of process to perform fast edge-based object relocalization or detection using contextual filtering.

FIG. 2B shows an example of a flow diagram of process to perform fast edge-based object relocalization or detection using contextual filtering.

FIG. 2C shows an example of a flow diagram of process to perform fast edge-based object relocalization or detection using contextual filtering.

FIG. 3A shows an example of objects and edge features in a RF and in a CF.

FIG. 3B shows an example of a typical object having edge features (e.g., edges with) locations, normals, and illumination gradients.

FIG. 3C shows a Sobel filter that may be used to obtain edge features.

FIG. 4 shows an example of an edge feature.

FIG. 5 shows an example of scales and changed locations of patches of edge features to a center location between the edge feature and the local extrema of the patch.

FIG. 6 shows an example of a binary descriptor for a patch based on boxes of luminance located at n pairs predetermined random locations.

FIG. 7 shows an example of weak initial feature matching.

FIG. 8 shows an example of local contextual filtering.

FIG. 9A shows an example of global contextual filtering.

FIG. 9B shows an example of a Hough Transform based on the angular difference and the illumination gradient magnitude difference for edge feature matches.

FIG. 10 shows an example of 3D pose/homography estimation.

FIG. 11 shows an example of a block diagram of a system in which aspects of embodiments of the invention may be practiced.

### DETAIL DESCRIPTION

Embodiments disclosed include methods, devices, systems and means for fast edge-based object re-localization and detection. Some embodiments are used for determining position and orientation (pose) of a camera in order to merge virtual and real world objects in images and video, such as to perform augmented reality in real time. Some embodiments provide relatively fast feature extraction based on determining edge orientation. In some embodiments, in order to determine the characteristic scale of edge features, initial weak feature matching of patches in the reference and current frame is combined with a strong contextual filtering framework of the frames. The disclosed embodiments achieve both computational efficiency of the extraction and good matching of the patches or features. The embodiments also improve the ability to determine a pose for objects having no or limited texture and without offline training of a system.

FIG. 1 is an example of a flow diagram of process 100 to perform object detection, tracking and relocalization, such as for 3D pose estimation or calculation. One or more embodiments described herein may apply to object relocalization techniques (e.g., block 140), which may be applied to a current frame of objects following a reference frame after a tracking failure to relocalize an object from the frame. Disclosed embodiments may also apply to initial detection (e.g., block 110) of objects in a frame such as during system start up where the current frame is the first frame and the reference frame is an image stored in memory of the device.

FIG. 1 shows block 110 where object detection (e.g., initial detection) is performed, such as to detect an object or portion of an object in a current image frame (CF). At block 110, detection may be performed for initial detection of an object and an initial camera pose. After detection, tracking may occur to track the object instances from the detected frame in the subsequent frames image by the camera. Thus, the initial frame used for detection becomes a prior frame for subsequent frames. In some embodiments, detection may involve using a reference image frame (RF) or frontal view, such as of a planar object in an image. In some cases, the reference image may be held in memory or an image taken by the user using the camera, or an image taken by the user of a downloaded image, or an image downloaded such as form the internet. Block 110 may include descriptions herein, such as those for FIGS. 2-11.

At block 120 object tracking is performed. At block 120, during tracking the objects, edges, and pose of the reference frame may be used to compute the object, edges and pose in a current subsequent frame or frames (e.g., a “current image frame” CF). In some cases, the current image frame (CF) or query image is an image taken by the user using the camera, such as in real time. In some embodiments, an “edge feature” may be defined as the location, normal, and magnitude of an edge pixel, which may correspond to the edge of an object (e.g., an edge “candidate”).

Tracking may determine camera pose by performing edge-based tracking in a sequence of frames or images taken by the camera. The edge based tracker may sample edges of objects (e.g., targets) in image frames obtained by the camera, such as by selecting certain edges to be tracked in subsequent frames to provide real time performance or calculation of the camera pose for the subsequent frames. The sampling may select “edgels” or sampling points of pixels of the object edges in a reference frame (RF) to be searched in a subsequent current frame (CF) in the tracking phase, such as from frame to frame of the images obtained by the camera. Block 120 may include processes as known in the art. [0026] The term “edgel” or “edge element” or “edge pixel”, may refer to an edge segment and may refer to a pixel in an image that has the characteristics of an edge in an imaged object.

At block 130 it is determined whether the tracking has failed. If tracking does not fail (e.g., succeeds), the process returns to block 120 to continue tracking the object. If tracking fails, the process proceeds to block 140 where object relocalization is attempted. At block 130, if subsequent frame tracking is lost, such as where an object needed for tracking cannot be located for a number of frames (e.g., for a sequence of 10 or more consecutive frames) or a period of time (e.g., say one second), the process may proceeds to relocalization step 140. The object may be lost due to camera movement, blur, or a change in the setting being imaged. Block 130 may include comparing the results of block 120 to a threshold, and/or other processes as known in the art.

At block 140, object relocalization is performed. At block 140, for relocalization, objects may be tracked without detection, from frame to frame. A failure of tracking may occur when one or more objects (or some threshold number of objects) cannot be detected after or in a number of subsequent frames (or threshold number of frames), which may be consecutive. In some embodiments, during step 140, the last frame prior to the failure of tracking may be used as the reference frame. In some embodiments, the last frame prior to the failure of tracking that includes or at least partially includes the object being relocalized may be selected. Typically the threshold for failing to track or localize an object during tracking is about 10 frames, however the number of frames used as the threshold may be varied in accordance with the application, performance criteria or other system parameters. In some embodiments, an assumption for relocalization is that the object being relocalized (e.g., from RF) is at least partially visible (e.g., in CF). In some cases, there are no constraints on the viewpoint of the reference or target image frame. In some embodiments, block 140 may include descriptions herein, such as those for FIGS. 2-11.

At block 150 it is determined whether the relocalization has failed. If relocalization does not fail (e.g., succeeds), the process returns to block 120 to continue tracking the object. If relocalization fails, the process proceeds to block 110 where object detection is attempted. Block 150 may include comparing the results of block 140 to a threshold, and/or other processes as known in the art.

FIG. 2A shows an example of a flow diagram of process to perform fast edge-based object relocalization or detection using contextual filtering, such as for 3D pose estimation or calculation. FIG. 2A shows an example of a process 200 for image based object detection or relocalization, such as for 3D pose estimation. Various embodiments of process 200 are explained herein. In some cases process 200 may performed or invoked by block 110 and or 140 of FIG. 1. In some cases process 200 may be performed by device 1100 of FIG. 11.

Process 200 may perform detection or relocalization of an object in a current image frame (CF) or “query image” from a reference image frame (RF). For instance, FIG. 3A shows an example of objects 320, 324, 326 and 330 and edge features 340 and 350 in a RF and in a CF. FIG. 3A shows objects 320, 324 and 326 having edge features in current query image frame (CF) 302. Object 320 has edge features 340. FIG. 3A also shows object 330 having edge features 350 in reference image frame (RF) 304. Thus, in some cases, process 200 may perform detection or relocalization of object 320 in a CF or Query Image 302 from a RF or Reference Image 304.

At block 210, a request to perform detection or relocalization is received. Block 210 may be optional in some embodiments. Block 210 may include receiving a request to perform detection (e.g., block 110) or relocalization (e.g., block 140), such as from a command, input, instruction or signal to perform detection or relocalization.

At block 220, a reference frame (RF) image and a current frame (CF) image are obtained. Block 220 may include obtaining reference frame (RF) 304 image data of an object 330; and current frame (CF) 302 image data of at least a portion of the object 320 (and optionally objects 324 and 326). According to embodiments, CF object 320 or edge features 340 may be at least a portion of the object 330 or features 350.

Obtaining RF image data may include using a reference image or frontal view, such as of a planar object in an image. In some cases, the reference image is in memory or an image taken by a user using the camera, or an image taken by the user of a downloaded image, or an image downloaded such as form the internet. Obtaining RF image data may include obtaining a current image taken by a user, using the camera, such as in real time. Block 220 may include descriptions above for block 110, 120, and/or 140 (such as relating to obtaining image data or edges). Block 220 may include obtaining one or more reference image frames (RF) and one or more current image frames (CF), such as is known in the art. In some cases, since there is no object information in the current frame at this time, the current frame and reference frame must be processed.

At block 230 edge features are extracted from (objects in) the RF and CF images. Block 230 may include extracting RF and CF edge features from the RF and CF image data. In some cases, edge features are extracted on a sparse grid using Sobel filtering followed by non-maximum suppression (NMS) along gradient direction. The output is the set of edge pixels with measured normal directions and gradient magnitudes. A low threshold may be used to filter out noise. In some embodiments, the operations may be designed for step edges.

Block 230 may include (e.g., as shown in FIG. 3A) obtaining or extracting RF edge features 350 of object 330 and CF edge features 340 of at least a portion of the object 330 (e.g., which is shown as object 320; one of objects 320, 324 and 326). This may be done as know in the art.

For instance, FIG. 3B shows an example of a typical object having edge features (e.g., edges with) locations, normals, and illumination gradients. FIG. 3C shows a Sobel filter that may be used to obtain these edge features (e.g., extracting edge features along every fourth pixel column or row). In some cases, an “edge” or an “edge feature” may refer to a pixel in an image that has the characteristics of an edge of an object imaged (e.g., an “edge pixel”). In some cases and edge or edge feature may be represented by a location (e.g., position) of an edge pixel, a direction normal to (e.g., orientation of) the edge at that location, and a magnitude (e.g., gradient) of the luminance in the normal direction at that location.

FIG. 3B shows typical object 360, with “edge” dot feature 362 having location 364 (“edge” dot), normal 366 (“normal” arrow direction), and illumination gradient 368 (“gradient” proportional to length of arrow). Feature 362 can be extracted along either vertical grids 372 or horizontal grids 374 (e.g., using a Sobel X and Y direction filters as shown in FIG. 3C). Features can be extracted along both the vertical and horizontal grids.

FIG. 4 shows an example of an edge feature, such as feature 462 (e.g., for a CF, for example). Block 230 may include filtering to obtain a location (e.g., “location” dot 464) (e.g., positions within the frame), a normal (e.g., “normal” arrows 366 and 466) (e.g., directions normal to the edge), and a gradient of illumination magnitude (e.g., length of normal arrows, representing a difference in illumination brightness across edge locations 364 and 464).

At block 230, the input may be the raw luminance of all pixels of a current frame (CF) and a reference frame (RF). The raw luminance may be in a range from 0-255, corresponding to color, RGB, BW, or conversion of color to grey scale, such as known in the art. The output may be the identification of all of the edge features (e.g., see the “edge feature” dots), feature locations (e.g., XY “location” coordinates of edge feature dots), normal directions (e.g., see the “normal” arrows) and gradient magnitudes. For the example of FIG. 3C, these may be extracted for every fourth row of raw pixel data luminance. Each extracted edge feature may be a “candidate” to be used for pose calculation (e.g., after further processing as described for blocks 230-290). Block 230 may be performed on the reference image and current frame so that edge features can be identified to subsequently select patches to be compared to identify similar features in the patches to determine the relocalization of the object.

At block 240 scale invariant patch selection is performed, for each edge feature. This may include performing scale selection and extracting patches based on or having the selected scales. Block 240 may include performing or selecting (e.g., identification of) patches and scales for each patch, for each edge feature. In some cases, block 240 may include performing scale selection and repeatability analysis. This may be performed on or for each edge feature (e.g., “candidate”) detected in or surviving block 230.

In some embodiments, the scale invariant edge features extraction of block 240 may be different or in contrast to that of other (e.g., conventional) scale invariant feature extraction techniques that compute either the characteristic scale, for instance by using the Difference of Gaussians (DOG) scale space, or extract features at multiple scales by simply sampling the scale space. In these cases, the corresponding scale may then be used to determine the orientation of the patch.

On the other hand, in some embodiments herein, scale invariant patch and scale selection (e.g., block 240) makes use of the edge orientation in order to determine the characteristic scale(s) of the edge feature. This may include using three steps. First, the intensity profile of the edge features may be extracted and run through a smoothing operator. Second, the edge profile gradients may be computed. And third, the locations of the local extrema along the profile may be used to define the characteristic scale(s). In some embodiments, the results may be obtained by first changing the actual feature location to the center between the feature location and the local maxima. In some cases, the scale of a patch may initially be defined as the distance of this point to the local extrema.

Block 240 may include extracting RF and CF edge features 340 and 350 from the CF and RF image data (e.g., see FIG. 3A). FIG. 4 also shows an example of gradients and patches for edge features (e.g., for a CF, for example). Block 240 may include calculating CF and RF edge profile illumination intensity gradients of the CF and RF image data 302-304 (e.g., “gradient” dots 422, 424 and 426) within a predetermined radius (e.g., “radius” dashed line 410) from a location 464 of each CF and RF 462 edge feature, and along a normal 466 direction of each CF and RF edge feature (e.g., calculating includes determining the gradient using the CF and RF image data).

Block 240 may then also include selecting CF and RF edge features 462 having at least one extrema of the CF and RF profile gradients within the predetermined radius (e.g., “gradient” dots 422, 424 and 426). The extrema may be a maximum or minimum calculated as compared to a max or min threshold.

In some cases, at block 240, first, an intensity profile may be extracted or determined for all of the pixels along the normal direction within a predetermined radius. The “intensity” may describe or be a level of luminance or brightness of a pixel. This process may be applied at multiple image scales using an image pyramid of the CF. The number of scales in the image pyramid or the size of the radius depend on the size of required viewing space where the object of interest needs to be detected. A number of scales may be selected and the scaling may be performed using image downsampling or the like.

In some cases, the radius may be fixed in size, such as a 64 pixel line centered at the edge feature (e.g., candidate). In some embodiments, the intensity profile may be determined in the normal direction identified for the edge feature so the output may be a one dimensional set of data representing luminance along the predetermined length centered at the edge feature. The intensity profile may be run through a smoothing operator, such as is known in the art.

The edge profile gradients along the luminance profile may then be computed to determine the transitions in brightness along the profile. Computing the edge profile gradients may be done using the SOBEL operator, or the like. This may provide an indication of where adjacent pixels have a large difference in intensity. Next, the locations of local extrema (e.g., maximums and minimums) of the profile gradients may be used to define the characteristic scale (e.g., one or more patches of each edge feature). In some cases, next, patches are extracted for each local extrema. In some cases, local extrema for each edge feature are extracted. This may include multiplying the distance between the feature and the extrema by an increase such as 1.1 or 1.2 times (e.g., a scale factor) and selecting a square region around the feature having that diameter. This leads to more distinctive patches due to a more diversified texture pattern within the region and therefore facilitates the matching process, at the cost of a higher risk of running over the image boundaries. So in some cases, the patch may be moved and shrunk (e.g., changed) to get more texture information for the object to which the edge feature belongs. Moving the location of the patch (e.g., to a changed location) may avoid or minimize the risk of patches running over the image boundaries, which provides the benefit of providing more patches for selection since, in some cases, patches that run over boundaries are discarded and not used for selection.

Block 240 may then also include identifying at least one CF and RF patch (e.g., “patch” boxes 452, 454 and 456) for each selected CF and RF edge feature based on at least one distance between the CF and RF edge feature and at least one location of a local extrema of the CF and RF profile gradients (e.g., distance lines 472, 474 and 476). In some embodiments, patch size may be a multiple between 1 and 1.2 of the distance between the CF and RF edge feature and at least one location of a local extrema of the CF and RF profile gradients (e.g., of distance lines 472, 474 and 476).

Block 240 may also include defining each patch as a square within the image having a center at the location of each CF and RF edge feature (then, possibly changed, as noted below), sides having length equal to twice the size of each patch, and a patch orientation equal to the normal of each CF and RF edge feature (e.g., patch sides oriented parallel and perpendicular to the normal of the CF and RF edge feature).

According to some embodiments, block 240 includes identifying a changed location of each CF and RF edge feature. FIG. 5 shows an example of scales and changed locations of patches of edge features to a center location between the edge feature and the local extrema of the patch. Block 240 may also include identifying a changed location of each CF and RF edge feature to a center location (e.g., “changed location” dots 522, 524 and 526) between the CF and RF edge feature and the local extrema. In some cases, this extrema may be as identified, but not the edge of patch located at a multiple between 1 and 1.2 of the distance between the CF and RF edge feature and at least one location of a local extrema.

In this case, Block 240 may include defining a scale S (e.g., “scale” distance lines 532, 534 and 536) of each at least one CF and RF patch (e.g., based on) as a distance between the changed location of each CF and RF edge feature and the location of the local extrema for each patch. In some cases block 240 includes changing the actual feature location to the center between the feature location and the local maxima; and defining the scale of that patch as the distance of this point to the local extrema.

At block 240, the input may be each CF and RF edge feature's location and normal; and raw frame luminance pixel data for all of the pixels of CF and RF. In some cases, block 240 processes the raw frame luminance pixel data for all of the pixels as input, but operates on or at each edge feature (e.g., candidate) location identified by the edge feature data extraction in block 230. The output may be the a (e.g., optionally changed) location of each CF and RF edge feature, at least one CF and RF patch for each CF and RF edge feature (e.g., each patch having a center, sides, and a side orientation), and a scale of each at least one CF and RF patch. One objective may be to obtain the scale or size measurement of a feature in a patch and an orientation of the patch for the feature. In other words, it may be desire or a benefit to know a patch size and orientation that includes the edge feature orientation based patches, for each edge feature. Block 240 may be performed on the reference image and current frame so that the patches can eventually be compared to identify similar features in the patches to determine the relocalization of the object.

At block 250, descriptors are computed for each patch. FIG. 6 shows an example of a binary descriptor for a patch based on boxes of luminance located at n pairs predetermined random locations.

In some cases, once the scale of the patch around the edge feature is estimated, binary descriptors are computed. In some cases, binary descriptors for RF and CF may be computed by comparing box filter responses at n random locations similar to BRIEF descriptors. The binary test locations may be rotated and scaled according to the estimated orientation and scale of edge features. For efficiency integral images may be used. The kernel size may be set proportional to the feature scale S. This may be done as know in the art.

In some cases, an example process for computing descriptors includes:
(1) computing binary descriptors (for each patch p) by comparing box filter responses at n random locations;

$$\text{?} ( \begin{matrix}{x}^{1} , … , \text{?} \\ {y}^{1} , … , \text{?}\end{matrix} )$$

$$\text{?} \text{indicates text missing or illegible when filed}$$

(2) rotating and scaling binary test location according to orientation Re and scale s of edge features: L_{s,θ}=sR_{θ}L, with rotated and scaled binary descriptor Dₙ(p,s,θ):=dₙ(p)I(xᵢ,yᵢ)^{T}εL_{θ}; and
(3) using a process (e.g., algorithm) including (a) computing an integral image, (b) where for each patch kernel size k is set proportional to feature scale s, and Dₙ is based on:
Binary tests:

$$t ( p ; x , y ) \text{:} = \{ \begin{matrix}1 \text{:} & p ( x ) < p ( y ) \\ 0 \text{:} & otherwise\end{matrix} \}$$

BRIEF descriptor:

$${d}_{n} ( p ) \text{:} = {\sum }_{1 \leq i \leq n}^{ } {2}^{i - 1} t ( p ; {x}_{i} , {y}_{i} )$$

Block 250 may include calculating a CF and RF patch binary descriptor (e.g., see descriptor 602) for each of the at least one CF and RF patch (e.g., see patch 454). This may include a calculating a descriptor for each edge feature by comparing the average luminance of pixels within boxes p(y) 612 and p(x) 614 of pixels located at n pairs of corresponding predetermined random locations within each patch 454. Each at least one CF and RF patch binary descriptor may include a binary data stream 602 having a bit (e.g., 632, 634) for each pair compared (e.g., 612/614 and 622/624) to form the n bits.

Block 250 may also include preselecting n random location pairs (x,y) that are rotated by R and scaled by S to compute each descriptor Dn for each patch p. For example, block 250 may also include rotating the location of the boxes based on the orientation of each at least one CF and RF patch (equal to the normal of each CF and RF edge feature) and scaling the boxes based on the scale of each at least one CF and RF patch.

At block 250, the input may be the raw frame luminance pixel data for all of the pixels of CF and RF within each at least one CF and RF patch; the orientation of each at least one CF and RF patch; and the scale of each at least one CF and RF patch. At block 250, the output may be an n equal length binary sequence for each patch representing comparisons of the same box locations of each patch.

In some cases, each descriptor may not be influenced by brightness or scale/size differences of the patches. Thus, using this data it should be possible to determine with a certain degree of confidence, whether any patch has edges in a configuration/shape similar to another patch. Block 250 may be performed on the reference image and current frame so that the descriptors of the patches can eventually be compared to identify similar features in the patches to determine the relocalization of the object.

At block 260, weak initial feature matching is performed. The matching may include using shallow Randomized Trees. During the training phase for all feature descriptors, the leaf index may be determined and stored at an address in memory that corresponds to the reference patch. At runtime during querying, first the leaf index may be determined and then the histogram of retrieved features may be computed for all ferns. Then only the retrieved features with a frequency above a certain threshold may be considered as corresponding edge features. Block 260, may quickly determine a set of potential RF patch matches for each CF. Thus, in some cases, blocks 260-280 may more quickly determine RF patch matches for each CF, than a process that does not include weak initial feature matching.

Block 260 may include comparing d random locations within each at least one CF patch binary descriptor with each at least one RF patch binary descriptors to identify a number of similar bits for each comparison. Block 260 may then include selecting N possible RF patch binary descriptor matches for each at least one CF patch binary descriptors based on the comparing (e.g., where the N possible matches have the most similar bits of any RF patch binary descriptor as compared to the CF descriptor). Block 260 may then include identifying N possible RF edge feature matches for each at least one CF edge feature based on the number of similar bits for each comparison (e.g., where the N possible edge feature matches are the edge features of the N possible RF patch binary descriptor matches).

FIG. 7 shows an example of weak initial feature matching. FIG. 7 shows comparing d (e.g., 4) random locations b, e, f and h of sequence a-h (e.g., n is 8) within CF patch binary descriptor D1 and RF patch binary descriptors D2 to identify a number of similar bits 3 for the 4 location. Based on these similar bits for each comparison of all CF patch binary descriptors with all RF patch binary descriptors, a predetermined threshold may be used to filter out, identify or select possible RF edge feature matches for each at least one CF edge feature. In some cases, the predetermined threshold may be based on a predetermined number of the similar bits (e.g., 2 of 4 matches). In some embodiments, the predetermined threshold may be based on a predetermined number of N matches (e.g., 2, 3 or 4) of possible RF edge features for each at least one CF edge feature. For example, the predetermined threshold may select the 3 closest possible RF edge features matches for a CF edge feature based on the number of similar bits for each comparison. These closest possible will be the 3 RF edge features having patches with the highest number of similar bits, while the other (e.g., 4^{th} plus) RF edge features will having patches with the fewer number of similar bit.

Block 260 may include that the binary descriptors of each patch of the reference frame needs to be compared to the current frame patch being matched to. Since the probability of the patches matching is only based on d random digits, N potential matches are identified for the patch being matched to. At block 260, the input may be all of the at least one CF and RF patch binary descriptors. At block 260, the output may be N possible RF edge feature matches for each at least one CF edge feature.

In some cases, block 260 includes selecting N “Ferns” of potential corresponding matches in the reference frame that are a match for each patch of the current frame. Because N of them may be selected (e.g., not a single sure match, but more than one potential matches), block 260 may be described as (e.g., considered) “weak” initial matching.

In some cases, N is between 15 and 20. In some cases, N may be a much greater than a 1 to 1 correspondence, such as by being 5, 10, 15, 20, 30, 50; or greater than, or in a range between any of those numbers. By selecting N of this magnitude, it may be possible to only use a depth d of random descriptor dimensions to compare each Fern. In some cases, d may be between 5 and 20. In some cases, d may be 5, 10, 15, 20, 30, 50; or greater than, or in a range between any of those numbers. In one embodiment, examples of d and N are 8 and 20. In some cases, d may be a predetermined number of locations (e.g., of the n locations used to provide or resulting in the binary descriptors) that are used to evaluate each potential corresponding match.

In some cases, block 260 decreases the possible matches and data being processed, while ensuring at least one of the n matches is a correct match. In some cases, d and N may be predetermined by training and evaluating testing for differences in selection on the system proportional to the type of objects, texture of objects, text, pictures, or other objects in images used to train the system for such selection. Training may set d and N for text, pictures and other objects such as so that it works for any of 1000 different images. In some cases, d and N are not relevant or effected by scale or lumination. They may also be based on the image size and/or number of pixels of the frames; such as a VGA, which is 640×480.

In some cases, only d random locations of the binary descriptors of each patch of the reference frame need to be compared to the current frame patch being matched to. Since the probability of the patches matching is only based on d random digits, N potential matches are identified for the patch being matched to. The relationship between N and d may not be linear. In some cases, d literally represents how similar the patches are, while N tells you how many possible same patches there are.

The “Fern” may be defined as a bunch of tests to see if the value is 0 or 1. In this case, one patches d random locations of the current frame binary data is compared with the same locations in the binary data of the patch of each reference frame, a Hamming Distance defined as the number of locations where the data is different (e.g. a 0 and a 1 instead of a 1 and a 1 or a 0 and a 0) is defined, the n patches of the reference frame with the lowest hamming distance are the output. In some cases, an example of the hamming distance for 11100 and 11111 is 2.

In some cases, block 260 determines which of the reference frame binary descriptors is closest to the current frame binary descriptors, being matched. In some cases, due to descriptor computation at block 250, each patch may have the same number of binary digits for the same sample pairs of luminance locations and scaled boxes.

At block 270, local contextual filtering is performed. This local filtering may include composite feature matching using dynamic programming. In some cases, by knowing (e.g., considering or predetermining) that at least one descriptor of the RF weak match patches is a match to the CF patch, it is possible to compare adjacent patches (e.g., descriptors) of each edge feature to enforce local ordering based on the normal direction of edge features (e.g., due to the patches being ordered based on the edge feature normal) (e.g., “local” contextual filtering).

At block 270, it may first be determined whether the binary descriptors are similar for each patch of the two edge features having weak matching patches. For example, the first binary descriptor for the edge feature of the current frame may be compared to each of each patch of the potential match edge descriptor of the reference frame using a Hamming distance. If the hamming distance of the binary data for the entire descriptors of each comparison is less than a threshold, or has the shortest hamming distance, and is below the threshold) those patches are identified as being the “similar” or the same. The threshold may be the same as used for the weak matching and may be determined similarly. The threshold may depend on the image size and/or number of pixels of the frames; such as a, VGA which is 640×480.

According to embodiments, although there was a weak match between at least one set of patches, the weak match was based on d random binary locations in the descriptor, while this comparison is for each or all the binary data in the two descriptors being compared. This comparison may be considered “strong” or stronger than that of the weak match.

In some cases, after the comparison of the first descriptor of the current frame, the second descriptor of the current frame is compared to all or all remaining descriptors for the edge feature of the reference frame. In some cases, dynamic programming is used to determine whether or not any of the identified corresponding or matching descriptors are out of sequence. In some cases, if they are out of sequence, then the edge features or candidates are “not compatible”: otherwise, if order is preserved, the features are “compatible.”

Block 270 may include comparing a first sequence of each at least one RF patch binary descriptor of each N possible RF edge feature matches to a second sequence of each at least one CF patch binary descriptor of each at least one CF edge feature. This may include determining which of the patches have descriptors that are “similar” as noted above. Block 270 may then include identifying as compatible ones of the N possible RF edge feature matches to each at least one CF edge feature, each of the N possible RF edge feature matches having the first sequence sequentially similar to the second sequence based on dynamic programming. In some cases, comparing includes determining a Hamming distance between each at least one RF patch binary descriptor of each N possible RF edge feature matches and each at least one CF patch binary descriptor of each at least one CF edge feature to identify the at least one RF patch binary descriptors that correspond with each the at least one CF patch binary descriptors.

FIG. 8 shows an example of local contextual filtering. FIG. 8 also shows CF edge feature 802 having patch sequence 804 having 3 patches with descriptors represented by values 2, 3, and 5 (e.g., descriptor representatives). FIG. 8 shows RF edge feature 812 having patch sequence 814 having 3 patches with descriptors represented by values 2, 4, and 5. Next FIG. 8 shows RF edge feature 822 having patch sequence 824 having 3 patches with descriptors represented by values 2, 5, 3, and 6. A comparison of sequence 804 and 814 is shown as Comp 1, where dynamic programming provides a sequential match of 2, 3, X, 5 and 2, X, 4, 5. This is a dynamic programming match even though the patches are not a perfect match, because the sequence of corresponding descriptors 2 and 5 is in the same order. It is in order 2 then 5 for both sequence 804 and 814.

A comparison of sequence 804 and 824 is shown as Comp 2, where dynamic programming provides a sequential non-match of 2, 3, 5, X and 2, 5, 3, 6. This is a dynamic programming non-match even though the patches are not a perfect match, because the sequence of corresponding descriptors 2, 3 and 5 is not in the same order. It is in order 2, 3 then 5 for sequence 804, but the 3 and 5 are reversed, and it is in order 2, 5 then 3 in sequence 814. Thus, RF edge feature 812 may be considered a compatible one of a subset of the N possible RF edge feature with CF edge feature 802; while feature 814 is not.

At block 270, the input may be the knowledge of which at least one RF patch binary descriptor is for each of the N possible RF edge features; the knowledge of which at least one CF patch binary descriptor is for each of the at least one CF edge features; the at least one RF patch binary descriptor of each N possible RF edge feature matches; and the at least one CF patch binary descriptor of each at least one CF edge feature. At block 270, the output may be those “ones” (e.g., a subset) of the N possible RF edge feature matches that have been found compatible with each at least one CF edge feature.

In some cases, because it is known from block 240 that the patches of each edge feature have the same orientation/normal and are in sequence from smallest to largest, block 270 compares the sequence of descriptors for patches of each edge feature to determine if the sequence in the CF is similar to that in the RF, for the potential matches from block 260. In some cases, it is known from block 240 that the binary descriptors are sequentially organized with patches having similar normals as neighbors for each edge feature, until the next edge feature is switched too. In other words, since the descriptors of the two patches have been calculated at block 240 by rotating and scaling the descriptors are irrelevant of orientation and luminance; thus, block 270 can select the normal direction known for the first edge feature of the current frame and identify which of the n weak match features of the reference frame have the same, or some of the same scale changes or comparisons for that normal, by comparing the descriptors of their patches. In some cases, block 270 includes a reliance on having, for each edge feature, determined and organized the sequence of the descriptors based on the edge normals of each feature, the different scales of each patch and the binary descriptors of each patch.

At block 280, global contextual filtering is performed. Global filtering may include performing contextual filtering of the matching feature from block 270, in the Hough Space. First, the parameter space may be built by computing the angular and magnitude differences between all corresponding pairs. For efficiency a look up table (LUT) may be used to determine the bin corresponding to the angle spanned by two vectors. Then the mean of both distributions may be estimated using the mean shift algorithm. All matches within a certain threshold around the modes may be considered as inliers.

Block 280 may include calculating an angular difference between the normal of each of the compatible ones of the N possible RF edge feature matches and the normal of each at least one CF edge feature. A LUT may be used to determine a bin corresponding to the angle spanned by the angular difference.

Block 280 may then include calculating an illumination gradient magnitude difference between the illumination gradient magnitude of each of the compatible ones of the N possible RF edge feature matches and the illumination gradient magnitudes of each at least one CF edge feature. Block 280 may then include performing a Hough Transform based on the angular difference and the illumination gradient magnitude difference for each of the compatible ones of the N possible RF edge feature matches and each at least one CF edge feature. Block 280 may then include identifying a set of normal and magnitude filtered compatible ones of the N possible RF edge feature matches having their Hough Transform greater than a NM threshold.

FIG. 9A shows an example of global contextual filtering. FIG. 9A shows CF 302 having edge features 801, 802 and 803 with direction normals 811, 812 and 813 and illumination magnitude gradients 821, 822 and 823. Next FIG. 9A shows RF 304 having edge features 901 and 902 with direction normals 911 and 912 and illumination magnitude gradients 921 and 922. FIG. 9A also shows (e.g., calculated) angular differences αi between normal 811 and 911; αj between normal 812 and 912; and αk between normal 813 and normals 911 and 912. As noted, a LUT can be used to determine a bin corresponding to the angle spanned by the angular difference.

Block 280 may also include determining (e.g., calculated) gradient difference between edge features 801, 802 and 803 and edge features 901 and 902. In some cases, a LUT can be used to determine a bin corresponding to the gradient differences of the edge features.

FIG. 9B shows Hough Transform 930 based on the angular difference and the illumination gradient magnitude difference for each of the compatible ones of the N possible RF edge feature matches and each at least one CF edge feature. FIG. 9B shows transform 930 having angular differences Δm 932 and magnitude differences Δg 934; with peak angular differences 942 and magnitude differences 944. The peaks may be defined by average values, highest values, or other known methods or processes. Transform shows matches 950 (e.g., normal and magnitude filtered compatible ones) of the N possible RF edge feature matches having their Hough Transform greater than a NM threshold 952.

In some cases, the median of both distributions are used to set threshold 952 for filtering based on the angular and magnitude differences of each potential edge feature match. All matches within threshold 952 around the modes may be considered as inliers. Outliers may be rejected. In some cases, the threshold may be chosen as between 1 and 3 times the standard deviation in both distributions. In some cases, the threshold may be chosen as between 2 and 3 times the standard deviation in both distributions. In one case, the threshold may be chosen as 2.5 times the standard deviation in both distributions.

At block 280, the input may be knowledge of the compatible ones of the N possible RF edge feature matches (e.g., that have been found compatible with each at least one CF edge feature); the normal of each of the compatible ones of the N possible RF edge feature matches; the normal of each at least one CF edge features; the illumination gradient magnitude of each of the compatible ones of the N possible RF edge feature matches; and the illumination gradient magnitudes of each at least one CF edge feature. At block 280, the output may be a set of normal and magnitude filtered compatible ones of the N possible RF edge feature matches having their Hough Transform greater than a NM threshold.

In some cases, at block 280, the angular difference between the normal of each edge feature of the current frame and each compatible weak math output edge feature of the reference frame is determined. The same process may be performed to compare the edge feature illumination gradient magnitudes. A Hough Transform may then be performed based on knowing the aggregate of the angular differences and each angular difference; and the aggregate of the magnitude differences and each magnitude difference. This may further filter the compatible weak match edge features of block 270, to an angular and magnitude filtered compatible weak match output.

In some cases, for efficiency a LUT may be used to determine the bin corresponding to the angle spanned by two vectors. Here, the angle differences may be quantized in bins of a lookup table. The number of bins may be selected to be between 10 and 25 bins. In some cases the number of bins may be selected to have bins of 5, 8, 10 or 15 degrees. In some cases there are binds of 10 degrees, for 18 bins.

At block 290, homography and affinity estimation is performed. In some cases, block 290 is described as “model fitting” or estimating a homography/affine matrix using the output of block 280. Block 290 may include using a line-based Homography/Affine estimation technique in conjunction with RANSAC. Thereby, instead of using the angular differences between the lines spanned by the edge features, it may use both distances and angles between the projected line segment endpoints and the corresponding lines. For more numerical stability data normalization may be performed independently in the reference and query images.

Block 290 may include estimating a homography or affine transformation matrix of ones of the set of normal and magnitude filtered compatible ones of the N possible RF edge feature matches. The transformation H may be the matrix that minimizes the distances and angles between the projected edge line segment endpoints from RF into CF and the corresponding lines in CF. The minimal number of line segments to compute the homography matrix is two. Thus, pairs of adjacent edge features in RF and their correspondences in CF are selected to generate a hypothesis for the homography between the two views. This hypothesis is then tested among all the other pairs within a RANSAC framework (e.g., a random sample consensus framework, such as known in the art).

In some cases, block 290 includes:
(1) Hypothesis testing:
   Between lines; angular difference between the lines spanned by the edge features,
   Between line segments: consider distances and angles between the projected edge line segment endpoints and lines,
(2) Data normalization increases numerical stability (Optional)
   Normalization: Translate and scale edge coordinates so that their centroid is at the origin, and average distance of the edge coordinates Pᵣ and is p_{q} the square root of 2:

p′ᵣ=Tᵣpᵣ,p′_{q}=T_{q}p_{q}

Estimate the Homography/Affine matrix

Denormalization: H=T_{q}⁻¹HTᵣ

Block 290 may then include randomly selecting or identifying a number of line segments of the each at least one CF edge features (e.g., surviving block 280), and then finding or picking the corresponding edge features and line segments in the RF (e.g., as known in the art). Block 290 may then include calculating differences in the distances between locations of (1) two line segment ends of the projected line segments of the RF of the ones of the set of normal and magnitude filtered compatible ones of the N possible RF edge feature matches, and (2) two line segment ends of the line segments of the CF of the each at least one CF edge feature. Block 290 may then include calculating differences in the angles between the line segment directions of (1) the projected line segments of the RF of the ones of the set of normal and magnitude filtered compatible ones of the N possible RF edge feature matches, and (2) the line segments of the CF of the each at least one CF edge features. Next, Block 290 may then include identifying a set of strong RF edge feature matches as ones of the set of normal and magnitude filtered compatible ones of the N possible RF edge feature matches that are part of projected line segments of the RF having differences in the distances below a first threshold and differences in the angles below a second threshold.

FIG. 10 shows an example of 3D pose/homography estimation. FIG. 10 shows CF 302 having two edge features 801 and 802 with normal directions 811 and 812; and the corresponding lines 1011 and 1012 defined by the edge feature directions. Next FIG. 10 shows RF 304 having edge features 901 and 902 with normal directions 911 and 912; and the corresponding line segments 1021 and 1022 having ends 1041/1042 and 1043/1044.

FIG. 10 also shows (e.g., calculated) distances D1/D2 between locations of (1) two line segment ends 1041/1042 and 1043 and 1044 of the projected line segment ends of the RF 1051/1052 and 1053/1054 (e.g., of the ones of the set of normal and magnitude filtered compatible ones of the N possible RF edge feature matches), and (2) two lines 1011/1012 defined by the extracted edge features of the CF.

FIG. 10 also shows (e.g., calculated) angle differences A1/A2 between the line segment directions of (1) two projected line segments of the RF 1051/1052 and 1053/1054 (e.g., of the ones of the set of normal and magnitude filtered compatible ones of the N possible RF edge feature matches), and (2) two lines 1011/1012 of the CF (e.g., of the each at least one CF edge feature).

In some cases, block 290 optionally includes performing normalization of the feature coordinates. Data normalization is used to increase numerical stability. The normalization is performed independently in the reference and current image. The normalization may translate and scale edge coordinates so that their centroid is at the origin, and the average distance is the square root of 2. At block 290, the output may be knowledge of the set of normal and magnitude filtered compatible ones of the N possible RF edge feature matches; locations of set of normal and magnitude filtered compatible ones of the N possible RF edge feature matches; and normals of set of normal and magnitude filtered compatible ones of the N possible RF edge feature matches. In some cases, the process of block 290 may not consider or include edge feature gradient or magnitude. At block 290, the output may the set of strong RF edge feature matches.

In some cases, block 290 includes considering small groups of edgels, the edgel normals and the edgel locations (e.g., such as 3, or another number as noted herein). Specifically, the distance between the locations or positions of the matched edge features from the current frame and reference frame of the prior global contextual filtering process may be compared to determine the distance between the locations and the difference between the angles or normal of the features that result from a line based homography/affine estimation technique of mapping each of the (e.g., three) corresponding pairs of edge features. In some cases, the more similar the mapping, the better, stronger, or closer (e.g. voting) the correspondence for that group. Thus, outliers may be further removed for groups where the correspondence is weak. It is considered that this may be described as a pretest or feedback of random groups of the prior compatible match output using RANSAC (RANdom SAmple Consensus) based model fitting to provide more robust features by indirectly testing the features before directly relating the features to determine pose. In some cases, the parameter test is a planar rotation and translation of the edgel location and normal, such as using a 3×3 matrix to determine the 9 parameters using homography for each of the edge feature matches. In some embodiments, groups of 3 edge features are selected at random for comparison until the edge feature's are exhausted; and the 9 parameters correspondence of the matrices may be a linear equation mapping. Also, according to some embodiments, the confidence level from the prior global CF filtering angular and magnitude comparisons (e.g., output of block 280) may be used or considered in selecting the groups of 3, such as based on the confidence from the CF filtering. For example, the higher confidence matches may be grouped together, or may be distributed with weaker confidence matches in other cases. Also, in some cases, a threshold can be selected for outputting or filtering through only the stronger groups of 3 edge features (e.g., where 3 is the predetermined number of adjacently located and similar normaled ones of the each at least one CF edge features, although other numbers can be used as noted herein).

At block 295 3D pose is estimated (e.g., determined or calculated). Block 395 may include estimating the 3D (e.g., 6 DOF) pose of the at least portion of the object in the CF using the strong RF edge feature matches (e.g., possibly normalized) and the each at least one CF edge feature (e.g., using the output of block 290). In some cases, the pose is estimated using or based on the set of strong RF edge feature matches selected at block 280. Using or based on this set, the pose may be estimated as known in the art.

In some embodiments, only block 240 is performed. In some embodiments, only block 260 is performed. In some embodiments, only block 270 is performed. In some embodiments, only block 280 is performed. In some embodiments, only block 290 is performed. In some embodiments, only any combination of blocks 240, 260, 270, 280 and 290 is performed. In each of these embodiments, any or all of the prior or other blocks are considered previous knowledge (e.g., provide data, such as stored in a memory, that is the output of the prior blocks) or are inherent but not necessary for these embodiments.

In some cases, by performing any single block or combination of blocks 240, 260, 270, 280 and 290 it is possible to detect texture-less objects using edge features without requiring a large training data set or a time consuming training stage (e.g., such as needed for other approaches). It is also possible to achieve fast and robust feature matching at run-time by combining a low cost edge-matching approach with a strong contextual filtering framework based on spatial relationship of edge features in the image. By using the above noted simple and relatively fast and invariant edge feature extraction method (e.g., blocks 230-240), then a weak initial matching (e.g., block 260), combined with a strong contextual filtering framework (e.g., blocks 270-280), and then a pose estimation framework based on edge segments (e.g., block 290), embodiments include edge detection using instant learning with a sufficiently large coverage area for object re-localization or detection. These embodiments also provide a good trade-off between computational efficiency of the extraction and matching processes.

FIG. 2B shows an example of a flow diagram of process 201 to perform fast edge-based object relocalization or detection using contextual filtering. At block 240 scale invariant patch and scale selection is performed, for each edge feature. Block 240 for FIG. 2B may include performing or selecting (e.g., identification of) patches and scales for each patch, including as described for block 240 for FIG. 2A. In some cases, FIG. 2B may include block 240 as described for FIG. 2A. In some cases, block 210 may be performed prior to FIG. 2B. In some cases, after block 240, process 201 may return to block 240.

In some cases, process 201 may include a machine implemented method to perform detection or relocalization of an object in a current frame (CF) image from a reference frame image (RF). For FIG. 2B, block 240 may include calculating CF and RF edge profile illumination intensity gradients of the CF and RF image data 302-304 (e.g., see dots 422, 424 and 426) within a predetermined radius (e.g., see dashed line 410) from a location 464 of each CF and RF 462 edge feature, and along a normal 466 direction of each CF and RF edge feature; selecting CF and RF edge features 462 having at least one extrema (e.g., maximum or minimum v. a threshold) of the CF and RF profile gradients within the predetermined radius (e.g., see dots 422, 424 and 426); and identifying at least one CF and RF patch (e.g., see boxes 452, 454 and 456) for each selected CF and RF edge feature based on at least one distance between the CF and RF edge feature and at least one location of a local extrema of the CF and RF profile gradients (e.g., see distance lines 472, 474 and 476) (e.g., patch size may be a multiple between 1 and 1.2 of the distance between).

FIG. 2C shows an example of a flow diagram of process 202 to perform fast edge-based object relocalization or detection using contextual filtering. At block 240 scale invariant patch and scale selection is performed, for each edge feature. Block 240 for FIG. 2C may include performing or selecting (e.g., identification of) patches and scales for each patch, including as described for block 240 for FIG. 2A. At block 270 local contextual filtering is performed. Block 270 for FIG. 2C may include local contextual filtering, including as described for block 270 for FIG. 2A. At block 280 global contextual filtering is performed. Block 280 for FIG. 2C may include performing global contextual filtering, including as described for block 280 for FIG. 2A. In some cases, after block 280, process 202 may return to block 240.

FIG. 11 is a block diagram of a system in which aspects of the invention may be practiced. The system may be device 1100, which may include a general purpose processor 1161, image processor 1166, pose processor 1168, graphics engine 1167 and a memory 1164. Device 1100 may also include a number of device sensors coupled to one or more buses 1177 or signal lines further coupled to the processor(s) 1161, 1166, and 1168. Device 1100 may be a: mobile device, wireless device, cell phone, personal digital assistant, mobile computer, tablet, personal computer, laptop computer, or any type of device that has processing capabilities.

In one embodiment device 1100 is a mobile platform. Device 1100 can include a means for capturing an image of a planar or non-planar target, such as camera 1114 (e.g., a still frame and/or video camera) and may optionally include motion sensors 1111, such as accelerometers, gyroscopes, electronic compass, or other similar motion sensing elements. Device 1100 may also capture images on a front or rear-facing camera (e.g., camera 1114). Any of the cameras may be able or used to capture or obtain RF and CF as described herein.

In some cases, device 1100 is a mobile camera, phone, system or device having a camera (e.g., capable of capturing a current image frame). The camera may be used for obtaining reference frame (RF) 304 image data of an object 330; and/or obtaining current frame (CF) 302 image data of at least a portion of the object 330. Thus, in some cases, the technology described herein is applicable to any camera having a display or coupled to a display where the camera or device is mobile (e.g. the camera is mobile).

The device 1100 may further include a user interface 1150 that includes a means for displaying the images and/or objects, such as display 1112. The user interface 1150 may also include a keypad 1152 or other input device through which the user can input information into the device 1100. If desired, integrating a virtual keypad into the display 1112 with a touch sensor may obviate the keypad 1152. The user interface 1150 may also include a microphone 1154 and speaker 1156, e.g., if the device 1100 is a mobile platform such as a cellular telephone. It should be appreciated that device 1100 may also include other displays; an additional or a different user interface (e.g., touch-screen, or similar); a power device (e.g., a battery); as well as other components typically associated with electronic devices. Of course, device 1100 may include other elements unrelated to the present disclosure, such as a satellite position system receiver.

Display 1112 may able or used to display any or all of RF, and CF including the object being tracked, as described herein. Display 1112 may also be able or used to display any or all of edges, poses, object detections and object relocalizations, as described herein.

When the device 1100 is a mobile or wireless device that it may communicate via one or more wireless communication links through a wireless network that are based on or otherwise support any suitable wireless communication technology. For example, in some aspects computing device or server may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A mobile wireless device may wirelessly communicate with other mobile devices, cell phones, other wired and wireless computers, Internet web-sites, etc.

A user's experience (e.g., of device 1100) can be greatly enhanced by providing improved object detection and/or relocalization devices, systems, software or processes as described herein. Such improvements may include using edge orientation based edge feature extraction, then a weak initial matching combined with a strong contextual filtering framework, and then a pose estimation framework based on edge segments, such as for determining a cameras pose, or camera pose updates.

In some embodiments, object detection and/or relocalization, as described herein, may be provided by logic of pose processor 1168. Such logic may include hardware circuitry, computer “modules”, software, BIOS, processing, processor circuitry, or any combination thereof. Such object detection and/or relocalization may include some or all of the processes described for of FIGS. 1, 2A-C and/or 1-10. Such logic may include an object detection or relocalization computer module to perform detection or relocalization of an object in a current frame (CF) image from a reference frame image (RF), such as to perform some or all of the processes described for of FIGS. 1, 2A-C and/or 1-10. Such logic may also include a pose calculation module to calculate 3D pose using the strong RF edge feature matches and the each at least one CF edge feature, such as to perform some or all of the processes described for block 295 of FIG. 2A. In some cases, these modules may be part of or included in pose processor 1168 or device 1100. In some embodiments, an object detection or relocalization computer module may perform some or all of blocks 110, 140 or 210-290; and a pose calculation module may perform real time camera position and orientation (pose) calculation based on the object detection or relocalization computer module results (e.g., at block 295, based on the results of block 290).

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processing unit. Memory may be implemented within the processing unit or external to the processing unit. As used herein the term “memory” refers to any type of long term, short term, volatile, nonvolatile, or other memory and is not to be limited to any particular type of memory or number of memories, or type of media upon which memory is stored.

In some embodiments, the teachings herein may be incorporated into (e.g., implemented within or performed by) a variety of apparatuses (e.g., devices, including devices such as device 1100). Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps (or processes) of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, flash memory, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions or modules described may be implemented in hardware (e.g., hardware 1162), software (e.g., software 1165), firmware (e.g., firmware 1163), or any combination thereof (which may be represented as pose processor computer module 1168). If implemented in software as a computer program product, the functions or modules may be stored on or transmitted over as one or more instructions or code on a non-transitory computer-readable medium, such as having data (e.g., program instructions) therein which when accessed by a processor causes the processor, and/or hardware to perform some or all of the steps or processes described herein. In some cases, a computer program product having a computer-readable medium comprising code for perform the processes described herein (e.g., any or all of FIGS. 2A-C). In some cases, an article of manufacture of a computer system comprising a non-transitory machine-readable medium having data therein which when accessed by a processor causes an object detection or relocalization computer module, or a pose calculation module to perform the processes described herein (e.g., any or all of FIGS. 2A-C).

Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. For example, the object being tracked may be interpreted or represented as a 2D or as a 3D object. Thus, the present invention is not intended to be limited to the embodiments shown herein but is to be accorded the widest scope consistent with the principles and novel features disclosed herein.

What is claimed is:

1. A machine implemented method to perform detection or relocalization of an object in a current frame (CF) image from a reference frame image (RF), comprising:
calculating CF and RF edge profile illumination intensity gradients of CF and RF image data within a predetermined radius from a location of each of a plurality of CF and RF edge features of a CF and a RF, and along a normal direction of each of the plurality of CF and RF edge features;
selecting CF and RF edge features having at least one extrema of the CF and RF profile gradients within the predetermined radius; and
identifying at least one CF and RF patch for each selected CF and RF edge feature based on at least one distance between the CF and RF edge feature and at least one location of a local extrema of the CF and RF profile gradients.

2. The method of claim 1, further comprising:
identifying a changed location of each CF and RF edge feature to a center location between the CF and RF edge feature and the local extrema; and
defining a scale of each at least one CF and RF patch as a distance between the changed location of each CF and RF edge feature and the location of the local extrema for each patch.

3. The method of claim 1, further comprising:
calculating CF and RF patch binary descriptors for each of the at least one CF and RF patch, wherein each at least one CF and RF patch binary descriptor include a binary data stream having a bit for each pair compared and having a same length as each other descriptor;
comparing d random locations within each at least one CF patch binary descriptor with each at least one RF patch binary descriptors to identify a number of similar bits; and
selecting N possible RF patch binary descriptor matches for each at least one CF patch binary descriptors based on the N possible matches have the most similar bits of any RF patch binary descriptor as compared to the CF descriptor.

4. The method of claim 3, further comprising:
identifying N possible RF edge feature matches for each at least one CF edge feature based on the selecting;
comparing a first sequence of each at least one RF patch binary descriptor of each N possible RF edge feature matches to a second sequence of each at least one CF patch binary descriptor of each at least one CF edge feature; and
identifying as compatible ones of the N possible RF edge feature matches to each at least one CF edge feature, each of the N possible RF edge feature matches having the first sequence sequentially similar to the second sequence based on dynamic programming.

5. The method of claim 4, further comprising:
calculating an angular difference between the normal of each of the compatible ones of the N possible RF edge feature matches and the normal of each at least one CF edge feature;
calculating an illumination gradient magnitude difference between the illumination gradient magnitude of each of the compatible ones of the N possible RF edge feature matches and the illumination gradient magnitudes of each at least one CF edge feature;
performing a Hough Transform based on the angular difference and the illumination gradient magnitude difference for each of the compatible ones of the N possible RF edge feature matches and each at least one CF edge feature; and
identifying a set of normal and magnitude filtered compatible ones of the N possible RF edge feature matches having their Hough Transform greater than a NM threshold.

6. The method of claim 5, further comprising:
identifying Homography and affine transformation matrix projected line segments of the RF having up to a predetermined number of adjacently located and similar normaled ones of the set of normal and magnitude filtered compatible ones of the N possible RF edge feature matches;
identifying line segments of the CF having up to a predetermined number of adjacently located and similar normaled ones of the each at least one CF edge features;
calculating differences in the distances between locations of two line segment ends of (1) the projected line segments of the RF of the ones of the set of normal and magnitude filtered compatible ones of the N possible RF edge feature matches, and (2) the line segments of the CF of the each at least one CF edge feature;
calculating differences in the angles between the line segment directions of (1) the projected line segments of the RF of the ones of the set of normal and magnitude filtered compatible ones of the N possible RF edge feature matches, and (2) the line segments of the CF of the each at least one CF edge features.
identifying a set of strong RF edge feature matches as ones of the set of normal and magnitude filtered compatible ones of the N possible RF edge feature matches that are part of projected line segments of the RF having differences in the distances below a first threshold and differences in the angles below a second threshold; and
calculating 3D pose using the strong RF edge feature matches and the each at least one CF edge feature.

7. The method of claim 6, further comprising displaying the strong RF edge feature matches and the each at least one CF edge feature on a display.

8. A device comprising:
an object detection or relocalization computer module to perform detection or relocalization of an object in a current frame (CF) image from a reference frame image (RF), the module configured to:
calculate CF and RF edge profile illumination intensity gradients of CF and RF image data within a predetermined radius from a location of each of a plurality of CF and RF edge features of a CF and a RF, and along a normal direction of each of the plurality of CF and RF edge features;
select CF and RF edge features having at least one extrema of the CF and RF profile gradients within the predetermined radius; and
identify at least one CF and RF patch for each selected CF and RF edge feature based on at least one distance between the CF and RF edge feature and at least one location of a local extrema of the CF and RF profile gradients.

9. The device of claim 8, the object detection or relocalization computer module further configured to:
identify a changed location of each CF and RF edge feature to a center location between the CF and RF edge feature and the local extrema; and
define a scale of each at least one CF and RF patch as a distance between the changed location of each CF and RF edge feature and the location of the local extrema for each patch.

10. The device of claim 8, the object detection or relocalization computer module further configured to:
calculate CF and RF patch binary descriptors for each of the at least one CF and RF patch, wherein each at least one CF and RF patch binary descriptor include a binary data stream having a bit for each pair compared and having a same length as each other descriptor;
compare d random locations within each at least one CF patch binary descriptor with each at least one RF patch binary descriptors to identify a number of similar bits; and
select N possible RF patch binary descriptor matches for each at least one CF patch binary descriptors based on the N possible matches have the most similar bits of any RF patch binary descriptor as compared to the CF descriptor.

11. The device of claim 10, the object detection or relocalization computer module further configured to:
identify N possible RF edge feature matches for each at least one CF edge feature based on the selecting;
compare a first sequence of each at least one RF patch binary descriptor of each N possible RF edge feature matches to a second sequence of each at least one CF patch binary descriptor of each at least one CF edge feature; and
identify as compatible ones of the N possible RF edge feature matches to each at least one CF edge feature, each of the N possible RF edge feature matches having the first sequence sequentially similar to the second sequence based on dynamic programming.

12. The device of claim 11, the object detection or relocalization computer module further configured to:
calculate an angular difference between the normal of each of the compatible ones of the N possible RF edge feature matches and the normal of each at least one CF edge feature;
calculate an illumination gradient magnitude difference between the illumination gradient magnitude of each of the compatible ones of the N possible RF edge feature matches and the illumination gradient magnitudes of each at least one CF edge feature;
perform a Hough Transform based on the angular difference and the illumination gradient magnitude difference for each of the compatible ones of the N possible RF edge feature matches and each at least one CF edge feature; and
identify a set of normal and magnitude filtered compatible ones of the N possible RF edge feature matches having their Hough Transform greater than a NM threshold.

13. The device of claim 12, the object detection or relocalization computer module further configured to:
identify Homography and affine transformation matrix projected line segments of the RF having up to a predetermined number of adjacently located and similar normaled ones of the set of normal and magnitude filtered compatible ones of the N possible RF edge feature matches;
identify line segments of the CF having up to a predetermined number of adjacently located and similar normaled ones of the each at least one CF edge features;
calculate differences in the distances between locations of two line segment ends of (1) the projected line segments of the RF of the ones of the set of normal and magnitude filtered compatible ones of the N possible RF edge feature matches, and (2) the line segments of the CF of the each at least one CF edge feature;
calculate differences in the angles between the line segment directions of (1) the projected line segments of the RF of the ones of the set of normal and magnitude filtered compatible ones of the N possible RF edge feature matches, and (2) the line segments of the CF of the each at least one CF edge features;
identify a set of strong RF edge feature matches as ones of the set of normal and magnitude filtered compatible ones of the N possible RF edge feature matches that are part of projected line segments of the RF having differences in the distances below a first threshold and differences in the angles below a second threshold;
and further comprising a pose calculation module to calculate 3D pose using the strong RF edge feature matches and the each at least one CF edge feature.

14. The device of claim 13, further comprising a display to display the strong RF edge feature matches and the each at least one CF edge feature.

15. A computer program product comprising a computer-readable medium comprising code to perform detection or relocalization of an object in a current frame (CF) image from a reference frame image (RF), the code for:
calculating CF and RF edge profile illumination intensity gradients of CF and RF image data within a predetermined radius from a location of each of a plurality of CF and RF edge features of a CF and a RF, and along a normal direction of each of the plurality of CF and RF edge features;
selecting CF and RF edge features having at least one extrema of the CF and RF profile gradients within the predetermined radius; and
identifying at least one CF and RF patch for each selected CF and RF edge feature based on at least one distance between the CF and RF edge feature and at least one location of a local extrema of the CF and RF profile gradients.

16. The computer program product of claim 15, further comprising code for:
identifying a changed location of each CF and RF edge feature to a center location between the CF and RF edge feature and the local extrema; and
defining a scale of each at least one CF and RF patch as a distance between the changed location of each CF and RF edge feature and the location of the local extrema for each patch.

17. The computer program product of claim 15, further comprising code for:
calculating CF and RF patch binary descriptors for each of the at least one CF and RF patch, wherein each at least one CF and RF patch binary descriptor include a binary data stream having a bit for each pair compared and having a same length as each other descriptor;
comparing d random locations within each at least one CF patch binary descriptor with each at least one RF patch binary descriptors to identify a number of similar bits; and
selecting N possible RF patch binary descriptor matches for each at least one CF patch binary descriptors based on the N possible matches have the most similar bits of any RF patch binary descriptor as compared to the CF descriptor.

18. The computer program product of claim 17, further comprising code for:
identifying N possible RF edge feature matches for each at least one CF edge feature based on the selecting;
comparing a first sequence of each at least one RF patch binary descriptor of each N possible RF edge feature matches to a second sequence of each at least one CF patch binary descriptor of each at least one CF edge feature; and
identifying as compatible ones of the N possible RF edge feature matches to each at least one CF edge feature, each of the N possible RF edge feature matches having the first sequence sequentially similar to the second sequence based on dynamic programming.

19. The computer program product of claim 18, further comprising code for:
calculating an angular difference between the normal of each of the compatible ones of the N possible RF edge feature matches and the normal of each at least one CF edge feature;
calculating an illumination gradient magnitude difference between the illumination gradient magnitude of each of the compatible ones of the N possible RF edge feature matches and the illumination gradient magnitudes of each at least one CF edge feature;
performing a Hough Transform based on the angular difference and the illumination gradient magnitude difference for each of the compatible ones of the N possible RF edge feature matches and each at least one CF edge feature; and
identifying a set of normal and magnitude filtered compatible ones of the N possible RF edge feature matches having their Hough Transform greater than a NM threshold.

20. The computer program product of claim 19, further comprising code for:
identifying Homography and affine transformation matrix projected line segments of the RF having up to a predetermined number of adjacently located and similar normaled ones of the set of normal and magnitude filtered compatible ones of the N possible RF edge feature matches;
identifying line segments of the CF having up to a predetermined number of adjacently located and similar normaled ones of the each at least one CF edge features;
calculating differences in the distances between locations of two line segment ends of (1) the projected line segments of the RF of the ones of the set of normal and magnitude filtered compatible ones of the N possible RF edge feature matches, and (2) the line segments of the CF of the each at least one CF edge feature;
calculating differences in the angles between the line segment directions of (1) the projected line segments of the RF of the ones of the set of normal and magnitude filtered compatible ones of the N possible RF edge feature matches, and (2) the line segments of the CF of the each at least one CF edge features;
identifying a set of strong RF edge feature matches as ones of the set of normal and magnitude filtered compatible ones of the N possible RF edge feature matches that are part of projected line segments of the RF having differences in the distances below a first threshold and differences in the angles below a second threshold; and
calculating 3D pose using the strong RF edge feature matches and the each at least one CF edge feature.

21. The computer program product of claim 20, further comprising code for displaying the strong RF edge feature matches and the each at least one CF edge feature.

22. A computing device to perform detection or relocalization of an object in a current frame (CF) image from a reference frame image (RF), comprising:
a means for calculating CF and RF edge profile illumination intensity gradients of CF and RF image data within a predetermined radius from a location of each of a plurality of CF and RF edge features of a CF and a RF, and along a normal direction of each of the plurality of CF and RF edge features;
a means for selecting CF and RF edge features having at least one extrema of the CF and RF profile gradients within the predetermined radius; and
a means for identifying at least one CF and RF patch for each selected CF and RF edge feature based on at least one distance between the CF and RF edge feature and at least one location of a local extrema of the CF and RF profile gradients.

23. The computing device of claim 21, further comprising:
a means for identifying a changed location of each CF and RF edge feature to a center location between the CF and RF edge feature and the local extrema; and
a means for defining a scale of each at least one CF and RF patch as a distance between the changed location of each CF and RF edge feature and the location of the local extrema for each patch.

24. The computing device of claim 21, further comprising:
a means for calculating CF and RF patch binary descriptors for each of the at least one CF and RF patch, wherein each at least one CF and RF patch binary descriptor include a binary data stream having a bit for each pair compared and having a same length as each other descriptor;
a means for comparing d random locations within each at least one CF patch binary descriptor with each at least one RF patch binary descriptors to identify a number of similar bits; and
a means for selecting N possible RF patch binary descriptor matches for each at least one CF patch binary descriptors based on the N possible matches have the most similar bits of any RF patch binary descriptor as compared to the CF descriptor.

25. The computing device of claim 24, further comprising:
a means for identifying N possible RF edge feature matches for each at least one CF edge feature based on the selecting;
a means for comparing a first sequence of each at least one RF patch binary descriptor of each N possible RF edge feature matches to a second sequence of each at least one CF patch binary descriptor of each at least one CF edge feature; and
a means for identifying as compatible ones of the N possible RF edge feature matches to each at least one CF edge feature, each of the N possible RF edge feature matches having the first sequence sequentially similar to the second sequence based on dynamic programming.

26. The computing device of claim 25, further comprising:
a means for calculating an angular difference between the normal of each of the compatible ones of the N possible RF edge feature matches and the normal of each at least one CF edge feature;
a means for calculating an illumination gradient magnitude difference between the illumination gradient magnitude of each of the compatible ones of the N possible RF edge feature matches and the illumination gradient magnitudes of each at least one CF edge feature;
a means for performing a Hough Transform based on the angular difference and the illumination gradient magnitude difference for each of the compatible ones of the N possible RF edge feature matches and each at least one CF edge feature; and
a means for identifying a set of normal and magnitude filtered compatible ones of the N possible RF edge feature matches having their Hough Transform greater than a NM threshold.

27. The computing device of claim 26, further comprising:
a means for identifying Homography and affine transformation matrix projected line segments of the RF having up to a predetermined number of adjacently located and similar normaled ones of the set of normal and magnitude filtered compatible ones of the N possible RF edge feature matches;
a means for identifying line segments of the CF having up to a predetermined number of adjacently located and similar normaled ones of the each at least one CF edge features;
a means for calculating differences in the distances between locations of two line segment ends of (1) the projected line segments of the RF of the ones of the set of normal and magnitude filtered compatible ones of the N possible RF edge feature matches, and (2) the line segments of the CF of the each at least one CF edge feature;
a means for calculating differences in the angles between the line segment directions of (1) the projected line segments of the RF of the ones of the set of normal and magnitude filtered compatible ones of the N possible RF edge feature matches, and (2) the line segments of the CF of the each at least one CF edge features;
a means for identifying a set of strong RF edge feature matches as ones of the set of normal and magnitude filtered compatible ones of the N possible RF edge feature matches that are part of projected line segments of the RF having differences in the distances below a first threshold and differences in the angles below a second threshold; and
a means for calculating 3D pose using the strong RF edge feature matches and the each at least one CF edge feature.

28. The computing device of claim 27, further comprising a means for displaying the strong RF edge feature matches and the each at least one CF edge feature on a display.
